(19) United States
(12) Patent Application Publication
(10) Pub. No.: US 2005/0127782 A1
(43) Pub. Date: Jun. 16, 2005

(54) Ultrasonic motor, and electronic timepiece having ultrasonic motor

(76) Inventors: Morinobu Endo, Suzaki-shi (JP); Tetsuo Uchiyama, Tokyo (JP); Akio Yamaguchi, Kasugai-shi (JP); Yasuo Kondo, Toyota-shi (JP); Hiroshi Aoyama, Nagoya-shi (JP); Koichiro Jujo, Kisarazu-shi (JP); Kazutoshi Takeda, Sakura-shi (JP); Masato Takenaka, Misato-shi (JP); Shigeo Suzuki, Ichikawa-shi (JP); Takeshi Tokoro, Tokyo (JP)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 10/499,689

(22) PCT Filed: Dec. 20, 2002
(86) PCT No.: PCT/JP02/13400

(30) Foreign Application Priority Data
Dec. 21, 2001 (JP) 2001-390279

(51) Int. Cl. H02N 2/12

(52) U.S. Cl. 310/323.02

(57) ABSTRACT

The invention relates to an ultrasonic motor, an electronic timepiece, and an electronic apparatus, which includes an ultrasonic rotor formed from a base resin of thermoplastic resin. Moreover, the invention includes an ultrasonic rotor which contacts with an ultrasonic stator under pressure, the ultrasonic rotor being formed from a filler containing resin. Alternatively an electronic timepiece with the ultrasonic motor is constructed. Furthermore, an electronic apparatus with the ultrasonic motor which is constructed.

### TECHNICAL FIELD

The present invention relates to an ultrasonic motor which includes an ultrasonic rotor formed from a base resin of thermoplastic resin. Moreover, the present invention relates to an electronic timepiece of an analog display type which has an indication wheel rotated by the rotation of an ultrasonic motor. Furthermore, the present invention relates to an electronic apparatus with an ultrasonic motor which has a power source, a source of oscillation, a controlling circuit, and an ultrasonic motor.

### BACKGROUND ART

Referring to FIG. 12, a conventional ultrasonic motor 930 includes an ultrasonic stator 922, an ultrasonic motor supporting member 924, an ultrasonic motor shaft 932, an ultrasonic rotor 934, and an ultrasonic motor lead substrate 936. The ultrasonic motor shaft 932 includes a guard part 932a, a first shaft part 932b. a second shaft part 932c, and a tip shaft part 932d. The ultrasonic motor supporting member 924 has a first through hole 924a for penetrating by the ultrasonic motor shaft 932 and a second through hole 924b for penetrating by a conducting pattern of the ultrasonic motor lead substrate 936. The ultrasonic motor supporting member 924 has this first through hole 924a penetrated by the ultrasonic motor shaft 932, and is adhered to the first shaft part 932b of the ultrasonic motor shaft 932. In the ultrasonic motor supporting member 924, the lower face of the ultrasonic motor supporting member 924 is abutted against the guard-part 932a of the ultrasonic motor shaft 932 The ultrasonic stator 922 has a central hole 922a, an ultrasonic stator main body 922b, a projection for enlarging displacement (comb teeth) 987, and a cylindrical part 922d. The projection 987 is provided on the surface of the ultrasonic stator main body 922b. The ultrasonic stator main body 922b is formed from aluminum alloy. The cylindrical part 922d projects from the back of the ultrasonic stator main body 922b, and the central hole 922a is formed to penetrate through the cylindrical part 922d.

A polarization processed piezoelectric element 802 is adhered to the,lower face of the ultrasonic stator main body 922b. The ultrasonic stator 922, with the central hole 922a through which the ultrasonic motor shaft 932 passes, is adhered to the second shaft part 932c of the ultrasonic motor shaft 932. The ultrasonic stator 922 is adhered to the ultrasonic motor shaft 932 in a condition where the outer peripheral portion of the central hole 922a, that is the end face of the cylindrical part 922d, is contacted with the upper face of the ultrasonic motor supporting member 924.

The ultrasonic motor lead substrate 936 is provided in order to apply an electric signal to the electrode provided in the piezoelectric element 982. The ultrasonic motor lead substrate 936 has a substrate main body 936d formed from insulating material such as polyimides, and conducting patterns 936a and 936b adhered to the substrate main body 936d. The face without the conducting patterns 936a nor 936b of the substrate main body 936d of the ultrasonic motor lead substrate 936, is adhered onto the back face of the ultrasonic motor supporting member 924.

The ultrasonic rotor 934 includes a rotating member 934c, a spring contacting member 934e, and a bearing jewel 934f. The ultrasonic rotor 934 is rotatably provided on the ultrasonic motor shaft 932 so that the lower face of the rotating member 934c contacts with the upper face of the projection 987 of the ultrasonic stator 922. The rotating member 934c is formed from carbon steel. The spring contacting member 934e is formed from polyacetal. The bearing jewel 934f is formed from ruby or ceramic. The pressurizing spring 938 contacts to the top of the spring contacting member 934e. The ultrasonic rotor 934 is contacted under pressure against the ultrasonic stator 922 by the elastic force of the pressurizing spring 938.

An ultrasonic motor driving circuit (not illustrated) generates an electric signal for driving the ultrasonic motor 930, and this electric signal is input to the piezoelectric element 982 through the conducting patterns 936a and 936b of the ultrasonic motor lead substrate 936. Based on this electric signal, oscillatory waves are generated in the ultrasonic stator 922 to which the piezoelectric element 982 is fixed. By this oscillating wave, the ultrasonic rotor 934, which contacts with the ultrasonic stator 922 under pressure, rotates. Configurations of conventional ultrasonic motors and the conventional electronic timepieces of the analog display type having an ultrasonic motor, have been disclosed, for example, in Japanese Patent No. 2764123, Japanese Unexamined Patent Application, First Publication No. H05-273361, Japanese Unexamined Patent Application, First Publication No. H11-215865, Japanese Unexamined Patent Application, First Publication No. H11-281772, and the like.

However, in a conventional ultrasonic motor the ultrasonic rotor 934 is composed of three parts. Therefore, the process for manufacturing the ultrasonic rotor 934 is complex. Moreover, since the rotating member 934c is made from metal and is thus heavy, the spring power of the pressurizing spring 938 must be adjusted to be small, so that it is difficult to design the pressurizing spring 938, In addition, since the coefficient of dynamic friction is about 0.1 to 0.4 in the natural material of polyacetal (polyoxymethylene) constituting the spring contacting member 934e, the spring power of the pressurizing spring 938 must be adjusted to be large, so that it is difficult to increase the wear resistance of the spring contacting member 934e. Moreover, since the coefficient of dynamic friction is about 0.1 to 0.4 in the natural material of polyacetal (polyoxymethylene) in the configuration of the ultrasonic rotor molded as a monolithic configuration of the polyacetal, the spring power of the pressurizing spring must be adjusted to be large. Therefore, it is difficult to increase the wear resistance of the spring contacting member, and it is difficult to increase the wear resistance of the bearing section of the ultrasonic rotor which contacts with the ultrasonic motor shaft.

Moreover, conventionally, in order to manufacture the ultrasonic rotor, a method where a large amount of powdery carbon black is added to the base resin has also been implemented. In the case where this ultrasonic rotor is installed in a conventional ultrasonic motor, it is necessary to lubricate the contact face of the ultrasonic rotor and the ultrasonic stator with oil to decrease the wear of the ultrasonic rotor. However, to decrease the wear of the ultrasonic rotor, it is necessary to add a large amount of carbon black to the base resin, which becomes a factor in increasing the manufacturing cost of the ultrasonic rotor. Moreover, since adhesion of the carbon black and the base resin is not good, if the ultrasonic rotor is worn even a little, there is the possibility that dust may be generated, and this dust may enter into the sliding parts of other members causing a decrease in performance of the equipment.

Moreover, regarding the basic characteristic of the ultrasonic motor, there is known to be the conflicting characteristic in that, if the spring power of the pressurizing spring is increased, the warm-up time becomes longer and the rotating torque of the ultrasonic motor becomes higher, while if the spring power of the pressurizing spring is decreased, the warm-up time becomes shorter and the rotating torque of the ultrasonic motor becomes lower. Therefore, in order to improve the basic characteristic of the ultrasonic motor, the spring power of the pressurizing spring must be controlled to a suitable value. Particularly, in the case where a large amount of carbon black is added to the base resin, the friction. coefficient on the surface of the ultrasonic rotor is decreased and the slipperiness in the contact face of the ultrasonic rotor and the ultrasonic stator is increased, so that it is very difficult to control the spring power of the pressurizing spring to a suitable value. In the case where the contact face of the ultrasonic rotor and ultrasonic stator is lubricated with oil, the oil deteriorates due to long term use, causing a shorter maintenance period of the equipment. Furthermore, in the case where the contact face of the ultrasonic rotor and ultrasonic stator is lubricated with oil, it is necessary to provide an oil retention construction for retaining the oil so that it is no flung out due to the impact on the equipment.

### DISCLOSURE OF INVENTION

The present invention is characterized in that, in an ultrasonic motor configured such that, by applying an electric signal to an electrode provided in a polarization processed piezoelectric element, oscillating waves are generated in an ultrasonic stator to which a piezoelectric element is fixed, and an ultrasonic rotor which contacts with this ultrasonic stator under pressure is driven, the ultrasonic rotor is formed from a filler containing resin having a base resin of thermoplastic resin, and carbon filler mixed with this base resin.

By such a configuration, it becomes possible to realize an ultrasonic motor which is stable in rotation performance of the ultrasonic rotor, and excellent in durability performance.

In the present invention, preferably the base resin is selected from a group consisting of, polystyrene, polyethylene terephthalate, polycarbonate, polyacetal (polyoxymethylene), polyamide, modified polyphenylene ether, polybutylene terephthalate, polyphenylene sulfide, polyether ether ketone, and polyether imide. Furthermore, in the present invention, preferably the carbon filler is selected from a group consisting of; a monolayer carbon nanotube, a multilayer carbon nanotube, a vapor growth carbon fiber, a nanografiber, a carbon nanohorn, a cup stack type carbon nanotube, a monolayer fullerene, a multilayer fullerene, and a mixture of any one of the carbon fillers doped with boron. Moreover the present invention, in an electronic timepiece of an analog display type which has a power source, a source of oscillation, a controlling circuit, a wheel train, and a time information display member, is characterized in including: the ultrasonic motor of the above mentioned aspect of the invention, an ultrasonic motor driving circuit for driving-the ultrasonic motor, and an indication wheel rotated by rotation of the ultrasonic motor. Furthermore the present invention, in an electronic timepiece of an analog display type which has a power source, a source of oscillation, a controlling circuit, a wheel train, and a time information display member, is characterized in including: the ultrasonic motor of the above mentioned aspect of the invention; an ultrasonic motor driving circuit for driving the ultrasonic motor; and an output member which operates by rotation of the ultrasonic motor.

The ultrasonic motor of the present invention includes an ultrasonic rotor formed from a filler containing resin having a base resin of carbon filler mixed with a base resin. The coefficient of dynamic friction of the filler containing resin can be made more than that of a no filler resin. Therefore, in the ultrasonic motor of the present invention, the frictional property between the ultrasonic rotor and the ultrasonic stator can be stabilized. Consequently, in the ultrasonic motor of the present invention, the spring power of a “pressurizing spring” which makes the ultrasonic rotor contact with the ultrasonic stator under pressure, can be easily adjusted.

Moreover, in the filler containing resin the specific wear rate is significantly less than for the no filler resin. Therefore, since the ultrasonic motor of the present invention includes the ultrasonic rotor formed from the filler containing resin, wear resistance of the contact area between the ultrasonic rotor shaft and the bearing, and wear resistance of the contact area between the ultrasonic rotor and the ultrasonic stator can be increased.

As a result, in an electronic timepiece or an electronic device having the ultrasonic motor of the present invention, it is easy to adjust the spring power of the “pressurizing spring” which makes the ultrasonic rotor contact with the ultrasonic stator under pressure. Moreover, the durability performance of the contact area between the ultrasonic rotor shaft and the bearing, and the contact area between the ultrasonic rotor and the ultrasonic stator, becomes excellent.

For example, in the case where the ultrasonic rotor is molded as just the ultrasonic rotor, the coefficient of dynamic friction is about 0.1 to 0.4 in the natural material of the polyacetal (polyoxylhethylene). On the other hand, in the case where the ultrasonic rotor is molded from the filler containing resin with a polyacetal base resin filled with a carbon filler, the coefficient of dynamic friction is about 0.55 for the filler containing resin, the coefficient of dynamic friction of the filler containing resin being larger than that for the polyacetal. Consequently, in the ultrasonic motor of the present invention, the frictional property of the ultrasonic rotor and ultrasonic stator is stable. Hence it is easy to adjust the spring power of the pressurizing spring. Moreover, in the case where the ultrasonic rotor is molded as just the ultrasonic rotor, the specific wear rate is about 2.2×10⁻⁴mm³/N·km for the natural material of the polyacetal. On the other hand, in the case where the ultrasonic rotor is molded from the filler containing resin with the polyacetal base resin filled with a carbon filler, the specific wear rate is about 3.3×10⁻⁹mm³/N·km, the specific wear rate of the filler containing resin being much smaller than that for the natural material of the polyacetal. Consequently, the ultrasonic motor of the present invention can be manufactured so that the wear resistance of the contact area between the ultrasonic rotor bearing section and the ultrasonic rotor shaft section, and the contact area between the ultrasonic rotor and the ultrasonic stator can be increased. Moreover, in an electronic timepiece or an electronic device having the ultrasonic motor of the present invention, it is easy to adjust the spring power of the pressurizing spring, and the durability performance of the contact area between the ultrasonic rotor and the ultrasonic stator is excellent.

### BRIEF DESCRIPTION OF THE DRAWINGS

FIG. 1 is a schematic cross-sectional view showing an embodiment of an ultrasonic motor of the present invention.

FIG. 2 is a plan view showing the appearance as seen from the obverse side, of the embodiment of the ultrasonic motor of the present invention.

FIG. 3 is a plan view showing the appearance as seen from the rear side, of the embodiment of the ultrasonic motor of the present invention.

FIG. 4 is a plan view showing an ultrasonic motor lead substrate used for the ultrasonic motor of the present invention.

FIG. 5 is an schematic plan view showing the appearance as seen from the obverse side, of an electronic timepiece in which the ultrasonic motor of the present invention is used, with some components omitted.

FIG. 6 is a schematic plan view showing the appearance as seen from the rear side, of the electronic timepiece in which the ultrasonic motor of the present invention is used, with some components omitted.

FIG. 7 is a block diagram showing a construction of the electronic timepiece in which the ultrasonic motor of the present invention is used.

FIG. 8 is a block diagram showing a configuration of a drive circuit of the ultrasonic motor of the present invention.

FIG. 9 is a plan view of an ultrasonic stator of the ultrasonic motor of the present invention.

FIG. 10 is a cross-sectional view of the ultrasonic stator of the ultrasonic motor of the present invention,

FIG. 11 is a fragmentary sectional view showing another construction of an electronic timepiece in which the ultrasonic motor of the present invention is used.

FIG. 12 is a schematic cross-sectional view of a conventional ultrasonic motor.

### BEST MODE FOR CARRYING OUT THE INVENTION

(1) Ultrasonic Motor Construction

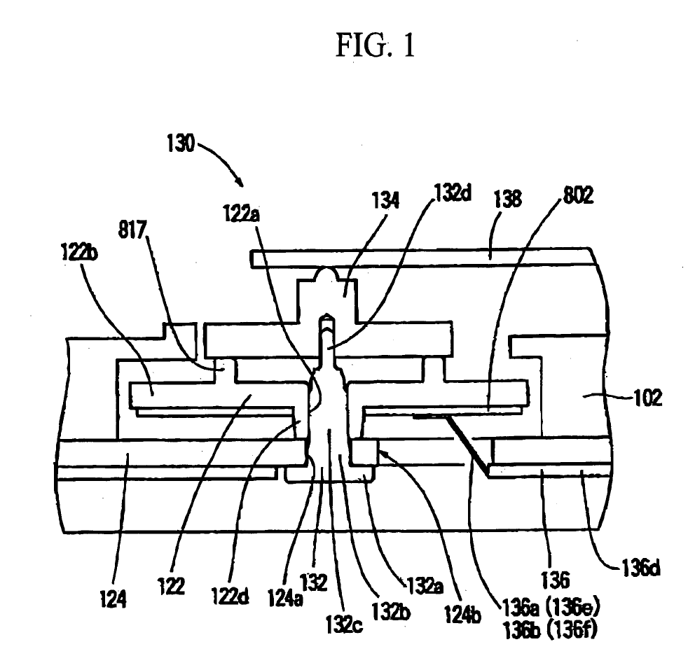

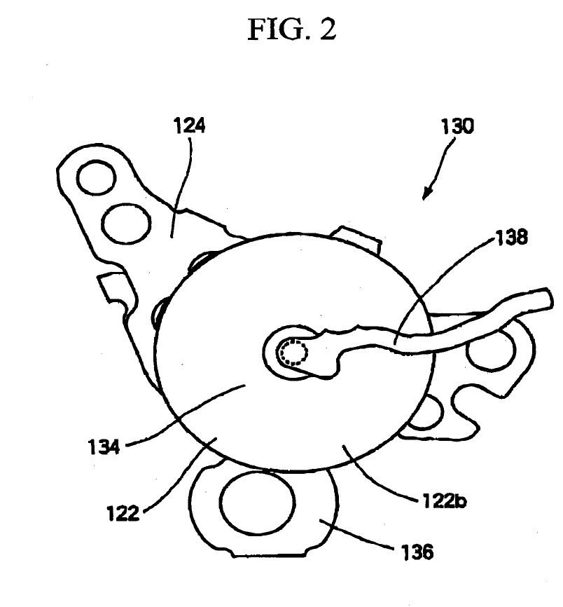

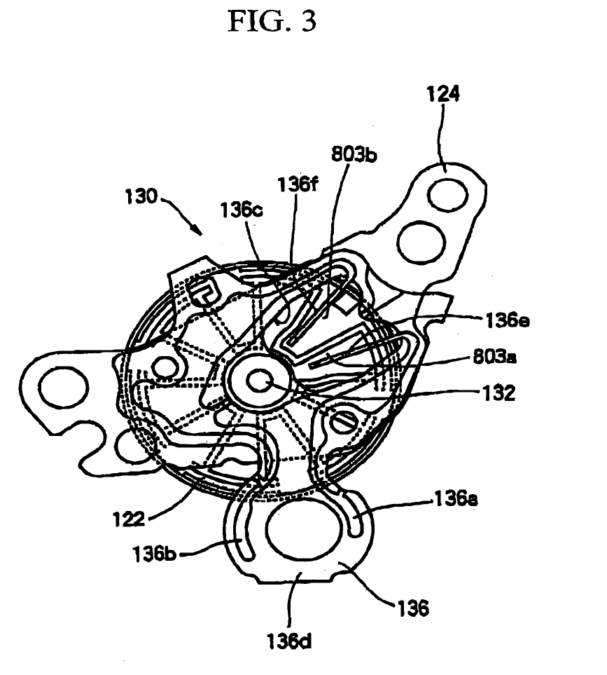

Referring to FIG. 1 to FIG. 3, an ultrasonic motor 130 of the present invention includes; an ultrasonic stator 122, an ultrasonic motor supporting member 124, an ultrasonic motor shaft 132, an ultrasonic rotor 134, and an ultrasonic motor lead substrate 136. The ultrasonic motor shaft 132 includes a guard part 132a, a first shaft part 132b, a second shaft part 132c, and a tip shaft part 132d.

The ultrasonic motor supporting member 124 has a first through hole 124a for penetrating by the ultrasonic motor shaft 132 and a second through hole 124b for penetrating by the conducting pattern of the ultrasonic motor lead substrate 136. The ultrasonic motor supporting member 124 has this first through hole 124a penetrated by the ultrasonic motor shaft 132, and is adhered to the first shaft part 132b of the ultrasonic motor shaft 132. In the ultrasonic motor supporting member 124, the lower face of the ultrasonic motor supporting member 124 is abutted against the guard part 132a of the ultrasonic motor shaft 132.

The ultrasonic stator 122 has a central hole 122a, an ultrasonic stator main body 122b, a projection for enlarging displacement (comb teeth) 817, and a cylindrical part 122. The projection 817 is provided on the surface of the ultrasonic stator main body 122b. The cylindrical part 122d projects from the back of the ultrasonic stator main body 122b, and the central hole 122a is formed to penetrate through the cylindrical part 122d. The ultrasonic stator main body 122b is formed from an elastic material such as aluminum alloy. A polarization processed piezoelectric element 802 is adhered to the lower face of the ultrasonic stator main body 122b. The ultrasonic stator 122, with the central hole 122a through which the ultrasonic motor shaft 132 passes, is adhered to the second shaft part 132c of the ultrasonic motor shaft 132. The ultrasonic stator 122 is adhered to the ultrasonic motor shaft 132 in a condition where the outer peripheral portion of the central hole 122a, that is the end face of the cylindrical part 122d, is contacted with the upper face of the ultrasonic motor supporting member 124.

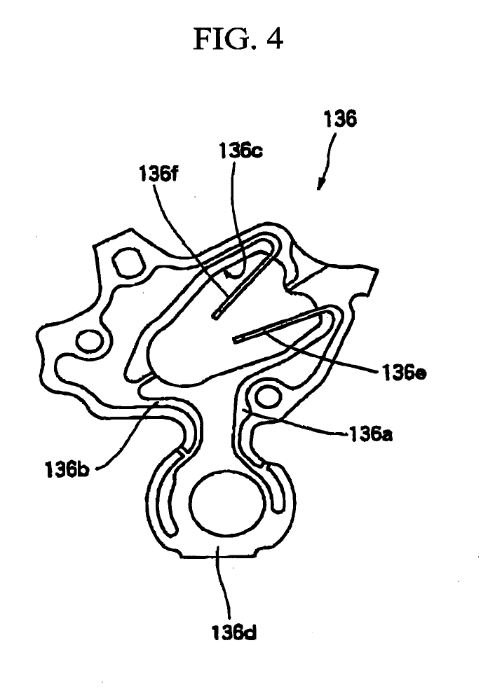

Referring to FIG. 4, the ultrasonic motor lead substrate 136 is provided in order to apply an electric signal to the electrode provided in the piezoelectric element 802. The ultrasonic motor lead substrate 136 has a substrate main body 136d formed from insulating material such as polyimides, and conducting patterns 136a and 136b adhered to the-substrate main body 136d. An opening 136c is provided in the substrate main body 136d. A tip part 136e of the conducting pattern 136a and a tip part 136f of the conducting pattern 136b are arranged in the opening 136c. Referring to FIG. 1 to FIG. 3 again, the face without the conducting patterns 136a nor 136b of the substrate main body 136d of the ultrasonic motor lead substrate 136, is adhered onto the back face of the ultrasonic motor supporting member 124. Preferably the ultrasonic motor lead substrate 136 is adhered to the ultrasonic motor supporting member 124 after the ultrasonic stator 122 is adhered to the ultrasonic motor shaft 132.

Next, the tip part 136e of the conducting pattern 13⁶a on the ultrasonic motor lead substrate 136 is welded to an electrode 803a of the piezoelectric element 802, and the tip part 136f of the conducting pattern 136b on the ultrasonic motor lead substrate 136 is welded to an electrode 803b of the piezoelectric element 802. As a modified example, the tip part 136e of the conducting pattern 136a may be soldered to the electrode 803a of the piezoelectric element 802, and the tip part 136f of the conducting pattern 136b may be soldered to the electrode 803b of the piezoelectric element 802. The ultrasonic rotor 134 is rotatably provided with respect to the ultrasonic motor shaft 132 so that a part on the lower face may contact with the upper face of the projection 817 of the ultrasonic stator 122. The pressurizing spring 138 contacts with the top of the spring contacting member 134e. The ultrasonic rotor 134 is contacted under pressure with the ultrasonic stator 122 by the elastic force of the pressurizing spring 138.

The ultrasonic rotor 134 is formed from a filler containing resin with a base resin of thermoplastic resin, and carbon filler filled into this base resin. If the ultrasonic rotor 134 is formed from the filler containing resin, wear of the bearing can be effectively prevented due to the filler. Consequently, the ultrasonic motor of the present invention has excellent durability performance of the bearing, and maintenance is facilitated.

The base resin used in the present invention is generally polystyrene, polyethylene terephthalate, polycarbonate, polyacetal (polyoxymethylene), polyamide, modified polyphenylene ether, polybutylene terephthalate, polyphenylene sulfide, polyether ether ketone, or polyether imide. That is, in the present invention, the base resin is preferably made of a so-called general-purpose engineering plastic or a so-called super engineering plastic. In the present invention, a general-purpose engineering plastic or a super engineering plastic other than the above can also be used for the base resin. It is preferable that the base resin used for the present invention is a thermoplastic resin. The carbon filler used in the present invention is generally; a monolayer carbon nanotube, a multilayer carbon nanotube, a vapor growth carbon fiber, a nanografiber, a carbon nanohorn, a cup stack type carbon nanotube, a monolayer fullerene, a multilayer fullerene, or a mixture of any one of the aforementioned carbon fillers doped with boron. Preferably the carbon filler is contained as 0.2 to 60% by weight of the total weight of the filler containing resin. Or preferably the carbon filler is contained as 0.1 to 30% by volume of the total volume of the filler containing resin.

Preferably the monolayer carbon nanotube has a diameter of 0.4 to 2 nm, and an aspect ratio (length/diameter) of 10 to 1000, specifically an aspect ratio of 50 to 100. The monolayer carbon nanotube is formed in a hexagon shaped netlike having -a cylindrical shape or a truncated-cone shape, and is a monolayer structure. The monolayer carbon nanotube can be obtained from Carbon Nanotechnologies Inc. (CNI) in the U.S.A. as “SWNT”.

Preferably the multilayer carbon nanotube has a diameter of 2 to 4 nm, and an aspect ratio of 10 to 1000, specifically an aspect ratio of 50 to 100. The multilayer carbon nanotube is formed in a hexagon shaped netlike having a cylindrical shape or a truncated-cone shape, and is a multilayer structure. The multilayer carbon nanotube can be obtained from NIKKISO as “MWNT”.

Such carbon nanotubes are described in “Carbon Nanotubes and Accelerated Electronic Applications” (“Nikkei Science” March, 2001 issue, pp 52-62) and “The Challenge of Nano Materials” (“Nikkei Mechanical” December, 2001 issue, pp 36-57) by P. G. Collins et. al., or the like. Moreover, the configuration and the manufacturing method of carbon fiber-containing resin composition has been disclosed for example in Japanese Unexamined Patent Application, First Publication No. 2001-200096.

Preferably the vapor growth carbon fiber has a diameter of 50 nm to 200 nm, and an aspect ratio of 10 to 1000, specifically an aspect ratio of 50 to 100. The vapor growth carbon fiber is formed in a hexagon shaped netlike having a cylindrical shape or a truncated-cone shape, and is a multilayer structure. The vapor growth carbon fiber can be obtained from SHOWA DENKO as “VGCF (trademark)”. The vapor growth carbon fiber has been disclosed for example in Japanese Unexamined Patent Application, First Publication No. H05-321039, Japanese Unexamined Patent Application, First Publication No. H07-150419, and Japanese Examined Patent Application, Second Publication No. H03-61768.

Preferably the nanografiber has an outer diameter of 2 to 500 nm, and an aspect ratio of 10 to 1000, an aspect ratio of 50 to 100 being particularly preferable. The nanografiber has an almost solid cylindrical shape. The nanografiber can obtained from ISE ELECTRON.

Preferably the carbon nanohorn has a diameter of 2 to 500 nm, and an aspect ratio of 10 to 1000, an aspect ratio of 50 to 100 being particularly preferable. The carbon nanohorn has an cup shape being a hexagon shaped netlike.

Preferably the cup stack type carbon nanotube has a shape where the carbon nanoborn is laminated into a cup shape, and an aspect ratio of 10 to 1000, an aspect ratio of 50 to 100 being particularly preferable.

Fullerene is a molecule which uses a carbon cluster as a parent. The definition of CAS, is that it is a molecule being a closed globular shape with 20 or more carbon atoms respectively combined with adjacent three atoms. Monolayer fullerene has a football like shape. Preferably the monolayer fullerene has a diameter of 0.1 to 500 nm. Preferably the composition of the monolayer fullerene is C60 to C540. The monolayer fullerene is for example C60, C70, and C120. The diameter of C60 is about 0.7 nm. Multilayer fullerene has a telescopic shape with the monolayer fullerene mentioned above concentrically laminated. Preferably the multilayer fullerene has a diameter of 0.1 nm to 1000 nm, a diameter of 1 nm to 500 nm being particularly preferable. Preferably the multilayer fullerene has a composition of C60 to C540. Preferably the multilayer fullerene has a configuration with for example C70 arranged on the outside of C60, and C120 arranged further on the outside of C70. Such multilayer fullerene has been described for example in “The Abundant Generation and Application to Lubricants of Onion Structured Fullerene” (“Japan Society for Precision Engineering” vol.67, No.7, 2001) by Takahiro Kakiuchi et. al.

Furthermore, the aforementioned carbon filler may also be made with any of the carbon fillers (a monolayer carbon nanotube, a multilayer carbon nanotube, a vapor growth carbon fiber, a nanografiber, a carbon nanohorn, a cup stack mold carbon nanotube, a monolayer fullerene, or a multilayer fullerene) doped with boron. The method of doping the carbon filler with boron is disclosed in Japanese Unexamined Patent Application, First Publication No. 2001-200096 or the like. In the method disclosed in Japanese Unexamined Patent Application, First Publication No. 2001-200096, the carbon fiber and boron manufactured by the gaseous-phase method, are mixed by a Henschel mixer type mixer, and this mixture is heat-treated at about 2300° C. in a high-frequency furnace or the like. Then, the heat-treated mixture is ground by a grinder. Next, the base resin and the ground mixture are blended at a predetermined rate, and melting and kneading carried out by an extruder in order to manufacture a pellet.

An ultrasonic motor driving circuit (not illustrated) generates an electric signal for driving the ultrasonic motor 130, and this electric signal is input to the piezoelectric element 802 through the conducting patterns 136a and 136b of the ultrasonic motor lead substrate 136. Based on this electric signal, oscillatory waves are generated in the ultrasonic stator 122 to which the piezoelectric element 802 is fixed. By this oscillating wave, the ultrasonic rotor 134, which contacts with the ultrasonic stator 122 under pressure, rotates. When the ultrasonic motor 130 of the present invention is used for an electronic timepiece (analog electronic timepiece), the ultrasonic motor supporting member 124 is preferably fixed to the main plate 102. In this case, the pressurizing spring 138 may be formed as a part of the components formed from an elastic material, such as a day wheel presser, a switch spring, and the like.

(2) Structure of Electronic Timepiece in Which Ultrasonic Motor is Used

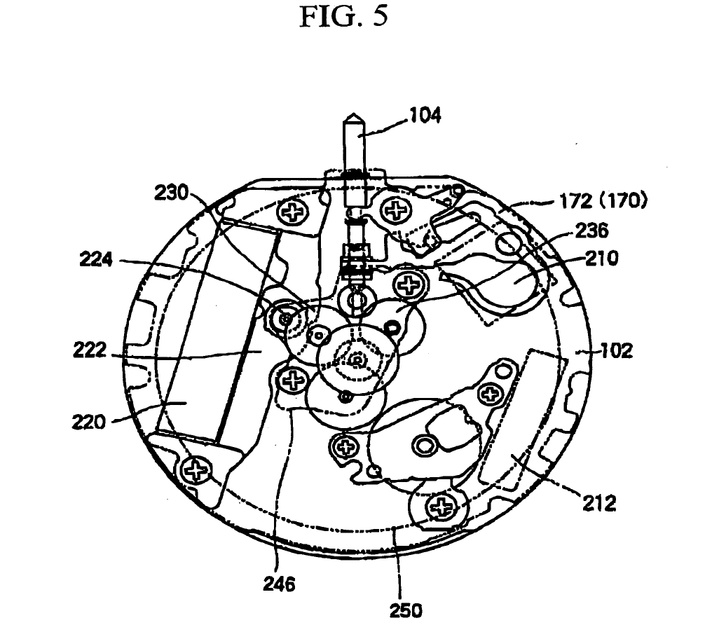

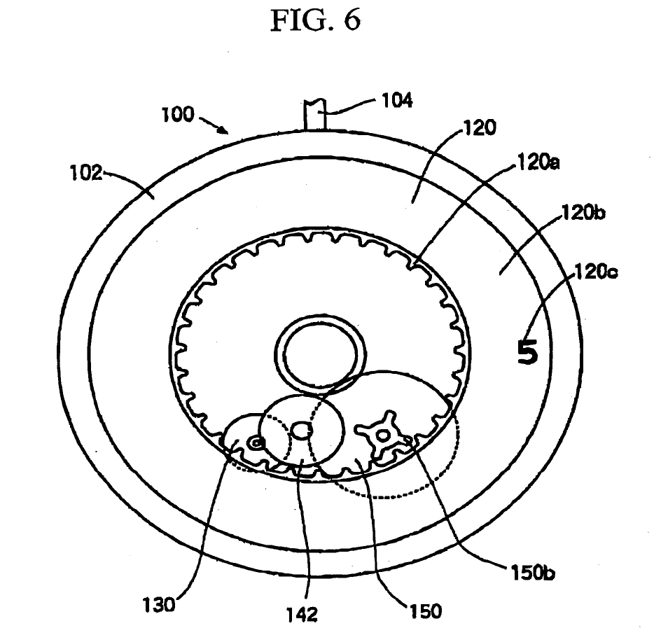

Next is a description of the structure of an electronic timepiece (analog electronic timepiece) in which the ultrasonic motor 130 of the present invention is used. Referring to FIG. 5 and FIG. 6, a movement 100 (machine body including the driving part) of the electronic timepiece in which the ultrasonic motor 130 of the present invention is used, is constituted by an analog electronic timepiece, and is provided with a main plate 102 constituting a base plate of the movement. A hand setting stem 104 is rotatably integrated to a hand setting stem guide hole of the main plate 102. A dial 104 (not illustrated) is attached to the movement 100. A switch device (not illustrated) operated by operating the hand setting stem 104, is provided in the main plate 102.

Among the both sides of the main plate 102, a side having the dial is referred to as the “rear side” of the movement 100, and the opposite side to the side with the dial is referred to as the “obverse side” of the movement 100. A wheel train integrated to the ” obverse side” of the movement 100 is referred to as an ” obverse wheel train”, and a wheel train integrated to the “rear side ” of the movement 100 is called a “rear wheel train”.

The switch device may integrated to the “obverse side” of the movement 100 or may be integrated to the “rear side” of the movement 100. The indication wheel such as a date indicator, a day of the week indicator or the like is integrated to the “rear side” of the movement 100. The date indicator 120 is rotatably arranged in the main plate 102. The date indicator 120 includes a date indicator wheel gear portion 120a and a date character print portion 120b. As an example of a date characters 120c, only “5” is shown in FIG. 6. The date indicator wheel gear portion 120a includes 31 date indicator teeth.

An ultrasonic motor 130 for rotating the date indicator 120 is arranged in the main plate 102. By using the ultrasonic motor 130, the date indicator 120 can be reliably rotated by a small number of reduction wheel trains. An intermediate date indicator driving wheel 142 is installed so that it may rotate based on the rotation of the ultrasonic rotor 134 of the ultrasonic motor 130. A date indicator driving wheel 150 is provided so that it may rotate based on the rotation of the intermediate date indicator driving wheel 142. The date indicator driving wheel 150 has four date feed gear parts 150b. The date feed gear part 150b is constituted to rotate the date indicator 120 by rotation of the date indicator driving wheel 150, The indication wheel rotated by the ultrasonic motor 130 may be a date indicator, a day of the week indicator, or other kinds of wheel which display information on time or calendar, for example, a month indicator, a year indicator, a lunar age indication wheel, or the like.

A circuit block 172 is arranged on the obverse side of movement 100. This circuit block 172 is provided with a circuit board 170, an integrated circuit 210, and a quartz oscillator 212. The movement 100 is provided a coil block 220, a stator 222, and a rotor 224. A fifth wheel-and-pinion 230 is arranged to rotate based on rotation of the rotor 224. A fourth wheel-and-pinion 232 is arranged to rotate based on rotation of the fifth wheel-and-pinion 230. A second hand 234 for indicating “second” is attached to the fourth wheel-and-pinion 232. A third wheel-and-pinion 236 is arranged to rotate based on the rotation of the fourth wheel-and-pinion 232. A minute indicator 240 is arranged to rotate based on the rotation of the third wheel-and-pinion 236. A minute hand 242 for indicating “minute” is attached to the minute indicator 240. A battery 250 is arranged on the circuit block 172 and a wheel train bridge 246.

(3) Operation of Electronic Timepiece in Which the Ultrasonic Motor is Used

Next, is a description of the operation of the electronic timepiece in which the ultrasonic motor of the present invention is used.

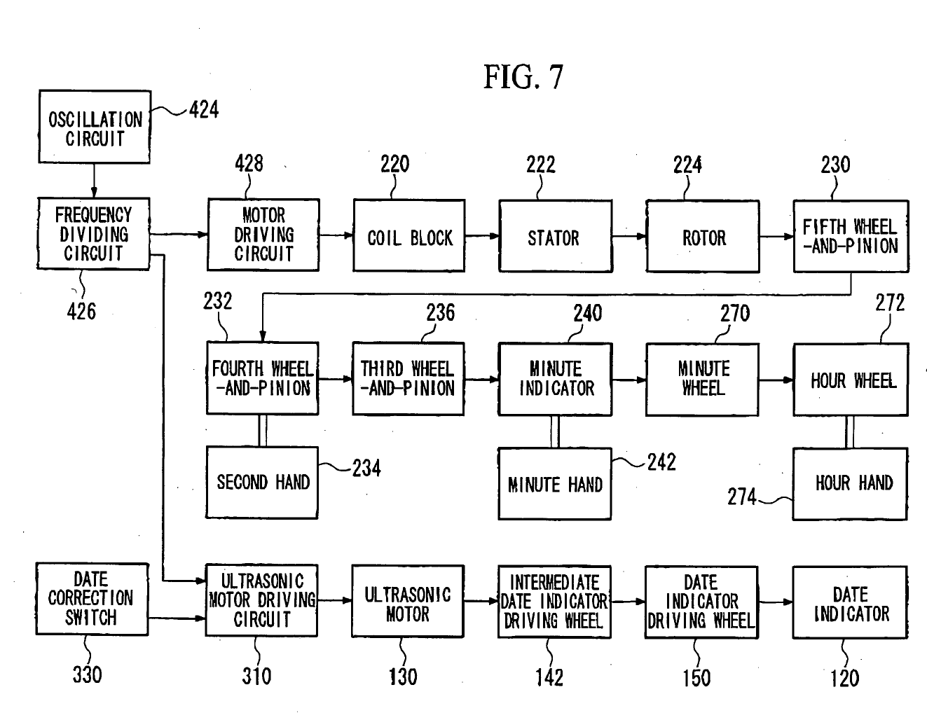

Referring to FIG. 7, an oscillation circuit 424 outputs a reference signal. The oscillation circuit 424 includes the quartz oscillator 212 constituting a source of oscillation. The quartz oscillator 212 is oscillated at, for example, at 32,768 Hz. Based on the oscillation of the quartz oscillator 212, a frequency dividing circuit 426 divides an output signal from the oscillation circuit 424. A motor driving circuit 428 outputs the motor drive signal for driving a step motor based on the output signal from the frequency dividing circuit 426. The oscillation circuit 424, the frequency dividing circuit 426, and the motor driving circuit 428 are incorporated in the integrated circuit 210. When the coil block 220 inputs the motor drive signal, the stator 222 is magnetized and rotates the rotor 224. The rotor 224 is rotated by, for example, 180 degrees per second. Based on rotation of the rotor 224, the fourth wheel-and-pinion 232 is rotated via rotation of the fifth wheel-and-pinion 230. The fourth wheel-and-pinion 232 is constituted to rotate once per minute. The second hand 234 is rotated integrally with the fourth wheel-and-pinion 232.

The third wheel-and-pinion 236 is rotated based on rotation of the fourth wheel-and-pinion 232. The minute indicator 240 is rotated based on rotation of the third wheel-and-pinion 236. The minute hand 242 is rotated integrally with the minute indicator 240. A slip mechanism (not illustrated) is provided in the minute indicator 240. When hand is set by the slip mechanism, in a state in which the minute hand 234 is stopped, the hand setting stem 104 is rotated by which the minute hand 242 and the hour hand can be rotated. The minute indicator 240 is rotated once per hour. A minute wheel 270 is rotated based on rotation of the minute indicator 240. An hour wheel 272 is rotated based on rotation of the minute wheel 270. The hour wheel 272 is rotated once per 12 hours. An hour hand 274 is attached to the hour wheel 272. The hour hand 274 is rotated integrally with the hour wheel 272.

An ultrasonic motor driving circuit 310 outputs an ultrasonic motor drive signal for driving the ultrasonic motor 130 based on an output signal from the frequency dividing circuit. 426. The ultrasonic motor driving circuit 310 incorporated in the integrated circuit 210. The intermediate date indicator driving wheel 142 is rotated based on rotation of the ultrasonic rotor 134 of the ultrasonic motor 130. The date indicator driving wheel 150 is rotated based on rotation of the intermediate date indicator driving wheel 142. By rotating the date indicator driving wheel 150, the date driving gear portion 150b rotates the date indicator 120. A signal output from the ultrasonic motor driving circuit 310, is output to rotate the date indicator 120 by one tooth per day. The date indicator 120 is constituted to be able to rotate by operating a date correction switch 330. When the date correction switch 330 is operated, the ultrasonic motor driving circuit 310 outputs the ultrasonic motor drive signal for driving the ultrasonic motor 130. By this constitution, indication of the date indicator 120 can be changed. The date correction switch 330 may be constituted to operate by operating the hand setting stem 104, or may be provided with a button or the like for operating the date correction switch 330.

(4) Operation of the Ultrasonic Motor

Next, is a description of the operation of the ultrasonic motor of the present invention.

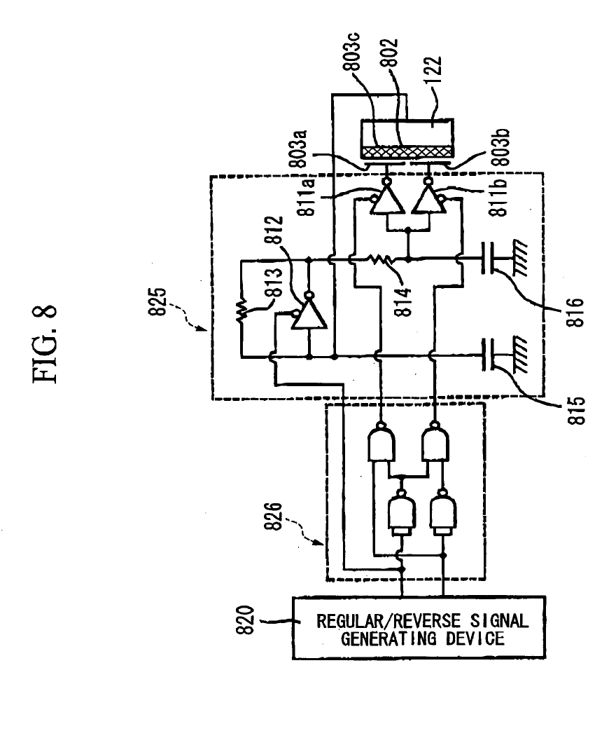

Referring to FIG. 8, a piezoelectric element 802 formed with two sets of electrode groups 803a and 803b each including a plurality of electrodes, is bonded to one face of the ultrasonic stator 122 constituting a vibrating member of the ultrasonic motor 130. An oscillation driving circuit 825 is connected to the electrode groups 803a and 803b of the piezoelectric element 802. An inverter 812 serves as an inverting power amplifier for inversely amplifying an electric signal which is excitation data from one face of the piezoelectric element 802 formed with the electrode groups 803a and 803b, and an electrode 803c or the ultrasonic stator 122 formed on the other face. A resistor 813 is connected in parallel with the inverter 812 for stabilizing an operating point of the inverter 812. An output terminal of the inverter 812 is connected to input terminal of two sets of buffers 811a and 811b via a resistor 814, The output terminal of the buffer 811a is connected to the electrode group 803a of the piezoelectric element 802. The output terminal of the buffer 811b is connected to the electrode group 803b of the piezoelectric element 802. One end of a capacitor 815 is connected to an input terminal of the inverter 812, and one end of a capacitor 816 is connected to the output terminal of the inverter 812 via the resistor 814. Respective other ends of the capacitors 815 and 816 are grounded for adjusting a phase in the oscillation driving circuit 825.

The inverter 812 and the buffers 811 a and 811 b are each provided with an input terminal, an output terminal, and a control terminal, and accordingly are an inverter or buffer having of a tri-state structure capable of bringing the output terminal into a high impedance state in accordance with a signal input to the control terminal. A regular/reverse signal generating device 820 outputs a regular/reverse signal for setting the rotational direction of the ultrasonic rotor 134 of the ultrasonic motor to a switching circuit 826. Output terminals of the switching circuit 826 are respectively connected to the control terminals of the tri-state buffers 811a and 811b, and the tri-state inverter 812 of the oscillation driving circuit 825, and makes one of the tri-state buffers 811a and 811b function as an ordinary buffer and disables the output terminal of other buffer by bringing the output terminal in a high impedance state based on output signals outputted from the regular/reverse signal generating device 820.

The oscillation driving circuit 825, the regular/reverse signal generating device 820, and the switching circuit 826 are included in the ultrasonic motor driving circuit 310. The ultrasonic stator 122 is driven by the tri-state buffer which is selected by the output signal from the switching circuit 826 and functions as an ordinary buffer. The ultrasonic stator 122 is driven only by the tri-state buffer permitted to function as an ordinary buffer by the switching circuit 826, and when the tri-state buffer permitted to function as an ordinary buffer by the switching circuit 826 is exchanged by an other one, the rotational direction of the ultrasonic motor is reversed. The output terminal of the tri-state inverter can be brought into the high impedance state by the output signal from the switching circuit 826 which is outputted based on the output from the regular/reverse signal generating device 820 and when the tri-state inverter is brought into a disabled state, both of the tri-state buffers 811a and 811b are brought into the disabled state by which rotation of the ultrasonic rotor 134 of the ultrasonic motor can be stopped.

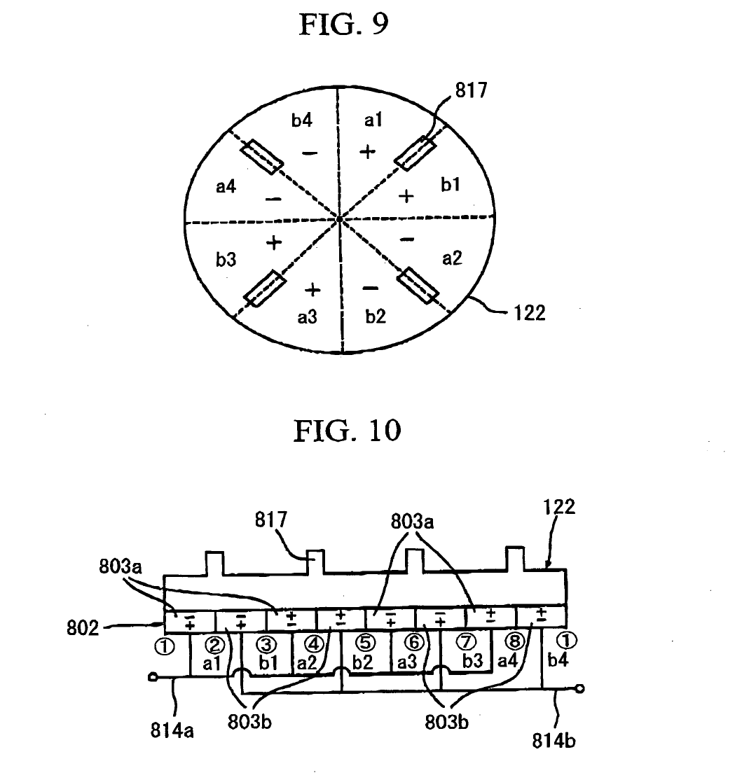

Referring to FIG. 9 and FIG. 10, the disc-shaped piezoelectric element 802 is bonded to the plane of the disk-shaped ultrasonic stator 122 by bonding, a thin film forming process, or the like. Standing waves of two wavelengths are excited in the circumferential direction of the ultrasonic stator 122 to thereby drive to rotate the ultrasonic rotor. The piezoelectric element 802 is formed with eight-divided electrodes, which is four times the number of waves in the circumferential direction alternately arranged on one plane, so as to give a first electrode group 803a and second electrode group 803b. As shown in FIG. 9 and FIG. 10 these groups are subjected to a polarization treatment of (+) and (−). The first electrode group 803a is constituted by electrodes a1, a2, a3, and a4, and the respective electrodes are short-circuited by a first connecting device 814a, The second electrode group 803b is constituted by electrodes b1, b2, b3, and b4, and the respective electrodes are short-circuited by a second connecting device 814b.

Symbols (+) and (−) in the drawing designate directions of the polarization treatment, and the polarization treatment is carried out by respectively applying positive electric fields and negative electric fields to a face of the piezoelectric element 802 bonded with the ultrasonic stator 122. Projections (comb teeth) 817 for enlarging displacement of the ultrasonic stator and transmitting drive force from the ultrasonic stator 122 to the ultrasonic rotor 134 are provided on the surface of the ultrasonic stator 122, at the vicinities of the boundaries the respective electrodes for every other electrode A high frequency voltage generated by the oscillation driving circuit 825 is applied to either one of the electrode groups 803a and 803b in order to excite standing waves of two wave lengths in the circumference direction of the ultrasonic stator 122, to thereby rotate and drive the ultrasonic stator 122. The rotational direction of the ultrasonic rotor 134 of the ultrasonic motor 130 is switched depending on which electrode group drives the ultrasonic stator 122.

Preferably the ultrasonic motor 130 of the present invention is driven by the construction including the ultrasonic motor driving circuit 3 1 0, the piezoelectric element 802, and the ultrasonic stator 122 of the above construction. However, it may be driven by an other construction. When a counted result of 12:00 at midnight is output, the ultrasonic motor driving circuit 310 outputs an ultrasonic motor drive signal to the ultrasonic motor 130. That is, the ultrasonic motor driving circuit 310 is configured to output an ultrasonic motor drive signal for rotating the date indicator 120 by 360°/31, that is, 1/31 rotations once a day, to the ultrasonic motor 130. The ultrasonic motor driving circuit 310 counts “year”, “month”, “day”, and time. When the calculation result of the ultrasonic motor driving circuit 310 outputs 12:00 at midnight of an ordinary day, in correspondence with the ordinary day is outputted to the ultrasonic motor 130. That is, the ultrasonic motor driving circuit 310 is constituted to output to the ultrasonic motor 130, the ultrasonic motor drive signal for rotating the date indicator 120 once per day, by 360°/31, that is, by a 1/31 rotation.

As described above, the ultrasonic motor 130 of the present invention is provided with the ultrasonic stator 122 bonded with the piezoelectric elements 802, and provided with the ultrasonic rotor 134 frictionally driven by oscillatory waves generated at the ultrasonic stator 122 by elongation and contraction of the piezoelectric element by inputting the ultrasonic motor drive signal. There are formed at least two sets of electrode groups each including a plurality of electrodes, on the surface of the piezoelectric element 802. The ultrasonic motor driving circuit 310 includes at least two power amplifiers, and output terminals of the power amplifiers are respectively connected to the two sets of electrode groups of the piezoelectric element to thereby drive to excite the respective electrodes independently from each other.

(5) Other Structure of Electronic Timepiece in Which Ultrasonic Motor is Used

Next is a description of an other structure of an electronic timepiece in which the ultrasonic motor of the present invention is used.

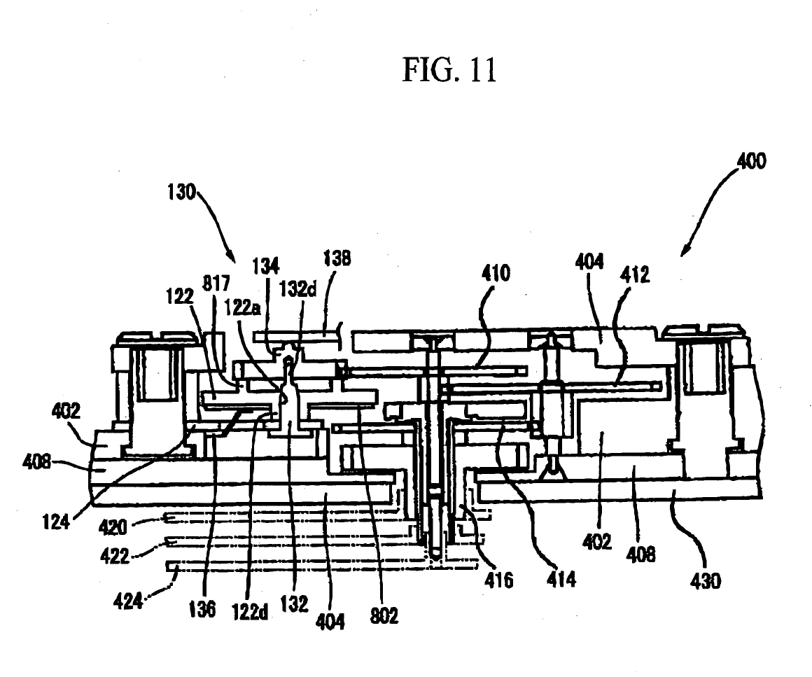

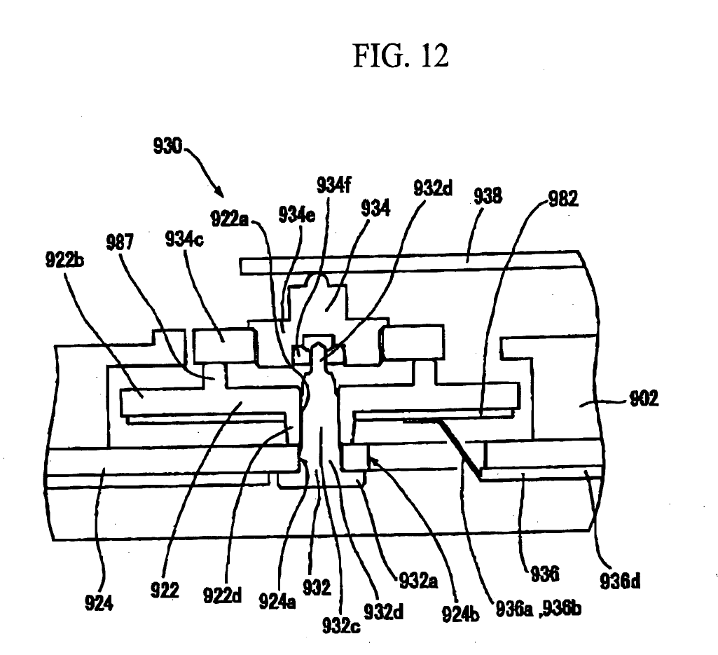

Referring to FIG. 11, a movement 400 (machine body including the driving part) of the electronic timepiece is constituted by an analog electronic timepiece, and is provided with a main plate 402 constituting a base plate of the movement 400. A dial 430 is attached to the movement 400. The movement 400 has the ultrasonic motor 130. The fourth wheel-and-pinion 410 is arranged to rotate based on rotation of the ultrasonic rotor 134. The gear section provided in the ultrasonic rotor 134 of the ultrasonic motor 130 meshes with the gear section provided in the fourth wheel-and-pinion 410 so that the fourth wheel-and-pinion 410 can rotate based on the rotation of the ultrasonic rotor 134. The fourth wheel-and-pinion 410 is constituted to rotate once per minute. A second hand 424 for indicating “second”, is attached to the fourth wheel-and-pinion 410. A third wheel-and-pinion 412 is arranged to rotate based on rotation of the fourth wheel-and-pinion 410. A minute indicator 414 is arranged to rotate based on rotation of the third wheel-and-pinion 412. The minute indicator 414 is constituted to rotate once per hour. A minute hand 422 for indicating “minutes”, is attached to the minute indicator 414. An hour wheel 416 is arranged to rotate based on rotation of the minute indicator 414.

The hour wheel 416 is constituted to rotate once in 12 hours. An hour hand 420 for indicating “hours”, is attached to the hour wheel 416. In the movement 400, the construction of the other parts is similar to a conventional analog electronic timepiece.

Next, is a description of the operation of the movement 400. Based on the oscillation of the quartz oscillator, a frequency dividing circuit divides an output signal from the oscillation circuit The oscillation circuit, the frequency dividing circuit, and the ultrasonic motor driving circuit (all not illustrated) are built into the integrated circuit (not illustrated). Based on the output signal from the frequency dividing circuit, the ultrasonic motor driving circuit outputs the ultrasonic motor drive signal which drives the ultrasonic motor 130. The fourth wheel-and-pinion 410 rotates based on the rotation of the ultrasonic rotor 134 of the ultrasonic motor 130. The fourth wheel-and-pinion 410 is constituted to rotate once per minute. The second hand 424 is rotated integrally with the fourth wheel-and-pinion 410. The third wheel-and-pinion 412 is rotated based on rotation of the fourth wheel-and-pinion 410. The minute indicator 414 is rotated based on rotation of the third wheel-and-pinion 412. The minute hand 422 is rotated integrally with the minute indicator 414. The minute indicator 414 rotates once per hour. A minute wheel (not illustrated) is rotated based on rotation of the minute indicator 414. The hour wheel 416 is rotated based on rotation of the minute wheel. The hour wheel 416 is rotated once per 12 hours. An hour hand 420 is attached to the hour wheel 416. The hour hand 420 is rotated integrally with the hour wheel 416.

The electronic timepiece in which the ultrasonic motor of the present invention is used, may also be provided with a calendar indication wheel for indicating other data in respect of a calendar, that is, “year”, “month”, “day of the week”, “six weekdays” or the like. In this case, the calendar indication wheel may be constituted so as to be rotated by rotation of the ultrasonic motor 130 via a reduction wheel train. Or, the calendar indication wheel may be constituted so as to be rotated by rotation of the hour wheel 416 via a reduction wheel train.

(6) Other Embodiments

In the above embodiments of the present invention, the present invention was described for the embodiment of an analog electronic timepiece including one motor and one ultrasonic motor, and the embodiment of an analog electronic timepiece including one ultrasonic motor. However, the present invention may be applied to; an analog electronic timepiece including a plurality of ultrasonic motors and one motor, may be applied to an analog electronic timepiece including one ultrasonic motor and a plurality of motors, or may be applied to an analog electronic timepiece including a plurality of ultrasonic motors and a plurality of motors. In the above embodiments of the present invention, the present invention was described for a so-called “disk shaped ultrasonic motor”. However, the present invention may be applied to a so-called “toric shaped ultrasonic motor”. Furthermore, the ultrasonic motor of the present invention may be applied to an electronic apparatus with an ultrasonic motor which has a power source, a source of oscillation, a controlling circuit, and the ultrasonic motor. Examples of such electronic apparatus with an ultrasonic motor include a vibration alarm timepiece, a vibration timer, a pocket-bell (registered trademark), a pager, a transceiver, a mobile telephone, and a warning machine, and the like. In such electronic apparatus with an ultrasonic motor, output member include a diaphragm, a rotation weight, an enunciating member, n display plate, and the like, which operate by rotation of the ultrasonic motor of the present invention. Moreover, the ultrasonic motor of the present invention can be applied to a measuring instrument, a printer, imaging equipment, recording equipment, a storage equipment, and the like. In such electronic apparatus-with an ultrasonic motor, an output member may include a gear, a cam, a plate member, or the like, which operates by rotation of the ultrasonic motor of the present invention.

In the above embodiments of the present invention, generally the base resin is polystyrene, polyethylene terephthalate, polycarbonate, polyacetal (polyoxymethylene), polyamide, a modified polyphenylene ether, polybutylene terephthalate, polyphenylene sulfide, polyether ether ketone, or polyether imide. polyether sulphone, polyethylene, nylon 6, nylon 66, nylon 12, polypropylene, ABS plastic, or AS resin, can also be used as the base resin. Moreover, two or more kinds of the above mentioned thermoplastic resins may be mixed to use as the base resin. Furthermore, an additive (antioxidant, lubricant, plasticizer, stabilizer, bulking agent, solvent, or the like) may be blended with the base resin used in this invention.

Next is a description of experimental data showing the coefficient of dynamic friction and the specific wear rate of the carbon filled resin used in the above embodiments, referring to TABLE. 1 and TABLE 2. TABLE. 1 shows the coefficient of dynamic friction, the specific wear rate, and the critical PV value of polyamide resin 12 (PA12), polyacetal resin (POM), and polycarbonate resin (PC) with a carbon filler of 20% by weight added.

In TABLE 1, VGCF (trademark) “Vapor Grown Carbo Fiber” is a resin with carbon filler of 20% by weight added. The characteristics of non-composite material to which carbon filler has not been added (resin only, that is PA12, POM, PC itself) are shown as “Blank” for comparison.

The respective resins mentioned above were injection mould under the molding conditions shown in TABLE. 2. That is, for a composite material of PA12 with carbon filler of 20% by weight added, the temperatures was 220° C. at the nozzle, 230° C. at the front section (metering section), 220° C. at the middle section (compressing section), 210° C. at the back section (supplying section), and 70° C. at the mold. For the non-composite material of PA12, the respective temperatures were 190° C., 200° C., 180° C., 170° C., and 70° C. For the composite material of POM with carbon filler of 20% by weight added, the above respective temperatures were 200° C., 210° C., 190° C., 170° C., and 60° C., and for the non-composite material of POM, the respective temperatures were 180° C., 185° C., 175° C., 165° C., and 60° C. For the composite material of PC with carbon filler of 20% by weight added, the above temperatures were 290° C., 310° C., 290° C., 270° C., and 80° C., and for the non-composite material of PC, the respective temperatures were 280° C., 290° C., 270° C., 260° C., and 80° C.

Here, coefficient of dynamic friction, specific wear rate (mm3/N·km), and critical PV value (kPa·m/s) denote the values when a resin piece of a predetermined shape (φ55 mm×thickness 2 mm) is slid along a copper sheet (S45C) at a speed of 0.5 m/sec while adding a face pressure of 50N.

These measuring methods are according to the plastic sliding wear test method (JIS K 7218 standard) (JIS: Japanese Industrial Standard).

In the case of polyacetal resin (POM), for the filler added material compared to the non-composite material (Blank), the coefficient of dynamic friction was about 1.5 times, and the specific wear rate was about 1/10000.

Incidentally, the rotating torque of the ultrasonic motor can be obtained by the following equation.
Rotating torque=“spring power of pressurizing spring,”×“coefficient of dynamic friction”×“radius from ultrasonic motor rotation center to pressurizing section”.

From the above, by forming the ultrasonic rotor 134 or the like from the carbon filled polyacetal resin (POM) in the above embodiments, it was found that the rotating torque was 1.5 times that of the non-composite material (Blank), even if the spring power of the pressurizing spring was the same.

On the other hand, although there is no qualitative equation regarding warm-up time (response time) of ultrasonic rotors 134 or the like, it is empirically known that the more the spring power of the pressurizing spring is increased, the longer the warm-up time becomes. Therefore, by forming the ultrasonic rotor 134 or the like from the carbon filled polyacetal resin (POM) in the above embodiments, the spring power of the pressurizing spring can be decreased compared to the non-composite material (Blank) even if the rotating torque is the same, so that warm-up time can be shortened.

In the case of polyamide resin (PA12), for the carbon filled material compared to the non-composite material (Blank), the coefficient of dynamic friction was about 1/2, but the specific wear rate was about 1/100. Therefore, by forming the ultrasonic rotor 134 or the like from the carbon filled polyamide resin in the above embodiments, the spring power of the pressurizing spring can be about 50 times that of the non-composite material (Blank), if the durability is equal, so that the rotating torque can be increased by about 50 times. On the other hand, in the case where equal torques are obtained, the spring power of the pressurizing spring should be doubled. However since the specific wear rate is about 1/100, the durability can be about 50 times.

In the case of polycarbonate resin (PC), for the carbon filled material compared to the non-composite material (Blank), the coefficient of dynamic friction was about 1/2.5, but the specific wear rate quantity was about 1/3. Therefore, by forming the ultrasonic rotor 134 or the like from the carbon filled polycarbonate resin in the above embodiments, even if the spring power of the pressurizing spring is increased 3 times that of the non-composite material (Blank), the abrasion loss becomes equal to that of the non-composite material (having 1 times the spring power). Therefore, by forming the ultrasonic rotor 134 or the like from the carbon filled polyamide resin, the spring power of the pressurizing spring can be increased by more than the drop of the coefficient of dynamic friction, so that the rotating torque can be increased.

### Industrial Applicability

The ultrasonic motor of the present invention includes an ultrasonic rotor formed from the filler containing resin with a base resin of carbon filler filled into a base resin. The index α (α=specific wear rate /coefficient of dynamic friction) of the filler containing resin can be decreased less than that of the no filler resin. The index a can be decreased by increasing the coefficient of dynamic friction, or decreasing the specific wear rate.

Now, in the case where the deflection when raising the pressurizing spring is fixed, the smaller the spring constant (spring constant=spring power/deflection), the smaller the fluctuation of the spring power with respect to the fluctuation change. Here, considering the case where the coefficient of dynamic friction is increased, since the spring power of a pressurizing spring required for generating the same rotating torque becomes smaller, the spring constant becomes small under the aforementioned condition where the deflection is constant. Therefore, stable spring power can be generated with respect to deflection fluctuation, so that the spring force of the “pressurizing spring” can be easily adjusted.

Moreover, considering the case where the specific wear rate of the filler containing resin is reduced, since the ultrasonic motor of the present invention includes the ultrasonic rotor formed from the filler containing resin, wear resistance of the contact area between the ultrasonic rotor shaft and the bearing, and wear resistance of the contact area between the ultrasonic rotor and the ultrasonic stator can be increased.

As a result, in an electronic timepiece or an electronic instrument having the ultrasonic motor of the present invention, it is easy to adjust the spring power of the “pressurizing spring” which makes the ultrasonic rotor contact with the ultrasonic stator under pressure. Moreover, the durability performance of the contact area between the ultrasonic rotor shaft and the bearing, and the contact area between the ultrasonic rotor and the ultrasonic stator, becomes excellent.

For example, in the case where the ultrasonic rotor is molded as just the ultrasonic rotor, the coefficient of dynamic friction is about 0.1 to 0.4 in the natural material of the polyacetal (polyoxymethylene). On the other hand, in the case where the ultrasonic rotor is molded from the filler containing resin with a polyacetal base resin filled with a carbon filler, the coefficient of dynamic friction is about 0.55 for the filler containing resin, the coefficient of dynamic friction of the filler containing resin being larger than that for the polyacetal. Consequently, in the ultrasonic motor of the present invention, the frictional property of the ultrasonic rotor and ultrasonic stator is stable. Hence it is easy to adjust the spring power of the pressurizing spring. Moreover, in the case where the ultrasonic rotor is molded as just the ultrasonic rotor, the specific wear rate is about 2.2×10⁻⁴ mm³/N·km for the natural material of the polyacetal. On the other hand, in the case where the ultrasonic rotor is molded from the filler containing resin with the polyacetal base resin filled with a carbon filler, the specific wear rate is about 3.3×10⁻⁹ mm³/N·km, the specific wear rate of the filler containing resin being much smaller than that for the natural material of the polyacetal. Consequently, the ultrasonic motor of the present invention can be manufactured so that the wear resistance of the contact area between the ultrasonic rotor bearing section and the ultrasonic rotor shaft section, and the contact area between the ultrasonic rotor and the ultrasonic stator can be increased. Moreover, in an electronic time piece or an electronic instrument having the ultrasonic motor of the present invention, it is easy to adjust the spring power of the pressurizing spring, and the durability performance of the contact area between the ultrasonic rotor and the ultrasonic stator is excellent.

TABLE 1

| | | PA12 | | POM | | PC | |
|---|---|---|---|---|---|---|---|
| | | VGCF | | VGCF | | VGCF | |
| Item | Units | 20 wt % | BLANK | 20 wt % | BLANK | 20 wt % | BLANK |
| Dynamic friction | | 0.25 | 0.56 | 0.55 | 0.35 | 0.18 | 0.51 |
| coefficient | | | | | | | |
| Specific wear rate | mm³/N · km | 3.8 × 10⁻¹³ | 5.2 × 10⁻¹¹ | 3.3 × 10⁻⁹ | 2.2 × 10⁻⁴ | 3.3 × 10⁻⁸ | 8.1 × 10⁻⁸ |
| Critical PV value | kPa · m/s | 1547 | 765(melt) | 1056(melt) | | 1056(melt) | 765(melt) |

TABLE 2

| | PA12 | | POM | | PC | |
|---|---|---|---|---|---|---|
| | VGCF | BLANK | VGCF | BLANK | VGCF | BLANK |
| NOZZLE | 220° C. | 190° C. | 200° C. | 180° C. | 290° C. | 280° C. |
| FRONT SECTION | 230° C. | 200° C. | 210° C. | 185° C. | 310° C. | 290° C. |
| MIDDLE SECTION | 220° C. | 180° C. | 190° C. | 175° C. | 290° C. | 270° C. |
| BACK SECTION | 210° C. | 170° C. | 170° C. | 165° C. | 270° C. | 260° C. |
| MOLD TEMP. | 70° C. | 70° C. | 60° C. | 60° C. | 80° C. | 80° C. |

1. An ultrasonic motor configured such that, by applying an electric signal to an electrode provided in a polarization processed piezoelectric element, oscillating waves are generated in an ultrasonic stator to which a piezoelectric element is fixed, and an ultrasonic rotor which contacts with this ultrasonic stator under pressure is driven,
wherein said ultrasonic rotor (134) is formed from a filler containing resin having a base resin of thermoplastic resin, and carbon filler mixed with this base resin.

2. An ultrasonic motor configured according to claim 1, wherein said base resin is selected from a group consisting of; a polystyrene, a polyethylene terephthalate, a polycarbonate, a polyacetal (polyoxymethylene), a polyamide, a modified polyphenylene ether, a polybutylene terephthalate, a polyphenylene sulfide, a polyether ether ketone, and a polyether imide.

3. An ultrasonic motor configured according to either one of claim 1 and claim 2, wherein said carbon filler is selected from a group consisting of, a monolayer carbon nanotube, a multilayer carbon nanotube, a vapor growth carbon fiber, a nanografiber, a carbon nanohorn, a cup stack type carbon nanotube, a monolayer fullerene, a multilayer fullerene, and a mixture of any one of the carbon fillers doped with boron.

4. An electronic timepiece of an analog display type which has a power source, a source of oscillation, a controlling circuit, a wheel train, and a time information display member, comprising:
the ultrasonic motor (130) according to any one of claim 1 through claim 3;
an ultrasonic motor driving circuit (310) for driving said ultrasonic motor; and
an indication wheel (120) rotated by rotation of said ultrasonic motor (130).

5. An electronic apparatus with an ultrasonic motor which has a power source, a source of oscillation, a controlling circuit, and an ultrasonic motor, comprising:
the ultrasonic motor (130) according to any one of claim 1 through claim 3;
an ultrasonic motor driving circuit (310) for driving said ultrasonic motor; and
an output member which operates by rotation of said ultrasonic motor (130).
